(19) United States
(12) Patent Application Publication
(10) Pub. No.: US 2010/0131498 A1
(43) Pub. Date: May 27, 2010

(54) AUTOMATED HEALTHCARE INFORMATION COMPOSITION AND QUERY ENHANCEMENT

(75) Inventors: Steven Linthicum, Lake in the Hills, IL (US); Steven Fors, Chicago, IL (US); Anthony Ricamato, West Chicago, IL (US); Eric Jester, Hoffman Estates, IL (US); Louis John Hoebel, Burnt Hills, NY (US); Gerald Bowden Wise, Clifton Park, NY (US); John Lizzi, Wilton, NY (US)

Correspondence Address: HANLEY, FLIGHT & ZIMMERMAN, LLC, 150 S. WACKER DRIVE, SUITE 2100, CHICAGO, IL, 60606, US

(73) Assignee: General Electric Company, Schenectady, NY (US)

(21) Appl. No.: 12/324,468

(22) Filed: Nov. 26, 2008

(51) Int. Cl. G06F 7/06; G06F 17/30

(52) U.S. Cl. 707/722; 707/E17.014; 707/E17.046; 707/758

(57) ABSTRACT

Certain embodiments of the present invention provide systems and methods for information composition and query enhancement. Certain embodiments provide an information composition and query enhancement system. The system includes a query generation and enhancement engine generating and conducting a query of one or more data sources based on user input and a data context to produce query results. The system also includes an information composition engine assembling the query results to provide a bundle of documents meaningful to the particular user. The system further includes a document summarization engine clustering and summarizing the bundle of documents to provide a content summary in addition to the bundle of documents for output in a presentation to a user.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during and/or after surgery, medical personnel may access patient information, such as images of a patient's anatomy, that are stored in a medical information system. Radiologist and/or other clinicians may review stored images and/or other information, for example.

Using a PACS and/or other workstation, a clinician, such as a radiologist, may perform a variety of activities, such as an image reading, to facilitate a clinical workflow. A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools. For example, a radiologist or cardiologist typically looks into other systems such as laboratory information, electronic medical records, and healthcare information when reading examination results.

Current PACS and/or other reviewing systems provide all available medical information on a screen for a user. However, this information is not organized. In addition, there is currently no way to tell the user which of these data elements are important and which are not. Simply browsing through data is quite problematic as it is a huge disruption in a physician's workflow and often fails to yield the desired end user results.

A variety of clinical data and medical documentation is available throughout various clinical information systems, but it is currently difficult to find, organize, and effectively present the information to physicians and other healthcare providers at a point of care. There are a myriad of difficulties associated with this task. Current systems and methods perform static queries on single data sources, which generally returns information which may or may not be relevant and is typically incomplete.

### BRIEF SUMMARY OF THE INVENTION

Certain embodiments of the present invention provide systems and methods for information composition and query enhancement.

Certain embodiments provide an information composition and query enhancement system. The system includes a query generation and enhancement engine generating and conducting a query of one or more data sources based on user input and a data context to produce query results. The system also includes an information composition engine assembling the query results to provide a bundle of documents meaningful to the particular user. The system further includes a document summarization engine clustering and summarizing the bundle of documents to provide a content summary in addition to the bundle of documents for output in a presentation to a user.

Certain embodiments provide a method for information composition and query enhancement across a healthcare enterprise. The method includes generating a query for a plurality of clinical data sources based on user input. The method also includes enhancing the query based on a particular data context for the requesting user. The method further includes searching the plurality of clinical data sources using the query to provide query results. The method additionally includes composing the query results into a bundle relevant to the requesting user. The method includes clustering the results in the bundle to provide a bundle of documents meaningful to the requesting user. The method also includes summarizing the clustered results to generate a content summary of the query results in the bundle. In addition, the method includes graphically providing the bundle of query results and the summary to the user.

Certain embodiments provide a machine readable medium including a set of instructions for execution by a computing machine. The set of instructions includes a query generation and enhancement engine generating and conducting a query of one or more data sources based on user input and a data context to produce query results. The set of instructions also includes an information composition engine assembling the query results to provide a bundle of documents meaningful to the particular user. The set of instructions further includes a document summarization engine clustering and summarizing the bundle of documents to provide a content summary in addition to the bundle of documents for output in a presentation to a user.

### BRIEF DESCRIPTION OF SEVERAL VIEWS OF THE DRAWINGS

FIG. 1 illustrates an information composition and query enhancement architecture in accordance with an embodiment of the present invention.

FIG. 2 depicts an example summarization algorithm.

FIG. 3 provides a system of underlying technologies used for each of the information composition and query enhancement components in accordance with an embodiment of the present invention.

FIG. 4 illustrates an information architecture provided to support retrieval, composition, and presentation of information from multiple, heterogeneous data sources.

FIG. 5 illustrates a workflow for providing adaptive, work-centered healthcare services in accordance with certain embodiments of the present invention.

FIG. 6 depicts a user interface architecture in accordance with certain embodiments of the present invention.

FIG. 7 shows a flow diagram for a method for query generation and result composition in accordance with an embodiment of the present invention.

FIG. 8 is a block diagram of an example processor system that may be used to implement systems and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments provide an end-user capability to support access to information across a complex healthcare enterprise including one or more information systems. Information is often scattered across multiple application silos, and clinical data and medical documentation are available throughout the various systems. Certain embodiments locate, organize, and effectively present the information to physicians and other healthcare providers at a point of care.

Information residing within healthcare information systems typically has certain characteristics. For example, information is distributed and often replicated across application silos. As another example, information is not indexed using common concepts, vocabulary or names. As a further example, information is stored using different mechanisms (e.g., file system, database, etc). As another example, information is represented in multiple media (e.g., text, audio, images, video, etc.). These characteristics make it difficult for traditional search engines to effectively find all of the information for a particular user need or query.

Healthcare providers are applying evidence-based medicine to provide better care to their patients. In addition, patients have a desire to not only understand their medical condition and treatment but also to collaborate with their care providers during their care. To support these new paradigms of care, both doctors and patients should be able to access medical data when they need it. To improve the value of collected data and to maximize insight, complex healthcare information systems need more effective capabilities to retrieve, organize, and present information.

Thus, certain embodiments provide a query enhancement engine, an information composition engine, a summarization engine, an information controller, and a knowledge base, for example. The query enhancement engine generates queries, searches data repositories, and filters results to find relevant information based on context, for example. The information composition engine composes and assembles retrieved information into an information bundle that is meaningful to the user. The summarization engine includes separate or combined single and multi-document summarization engine(s) to provide summaries of content, clustering, identification of salient themes of retrieved information, for example. The information controller provides structure and interactive access to retrieved information and enables use of diverse visualization strategies to effectively present information. The knowledge base provides models of users, events, and information to enable utilization of semantic relationships, for example.

Dynamic information retrieval leverages natural language processing (“NLP”) and semantic technologies to enable dynamic generation of queries to improve retrieval of relevant information. Dynamic information composition leverages semantic knowledge about a domain (e.g., ontologies and models), contextual information, and user preferences to compose, summarize, and organize information in a manner that is meaningful to the user. Semantic modeling leverages semantic technologies to model domain concepts; user tasks and roles; and information types and relationships to improve retrieval, composition, and presentation of information. An information architecture is disclosed to support retrieval, composition (e.g., bundling), and presentation of information from multiple, heterogeneous data sources, for example.

Certain embodiments provide systems and methods to find, organize, summarize, and effectively visualize information across an entire enterprise to physicians and other healthcare providers at a point of care. Currently, healthcare providers must access many different machines and gather this information from many different applications and then must manually synthesize a coherent understanding of all that data.

Certain embodiments provide access by an end user to information across enterprise systems. Certain embodiments provide a search-driven, role-based, workflow-based, and/or disease-based interface that allows the end user to access, input, and search medical information seamlessly across a healthcare network. Certain embodiments offer adaptive user interface capabilities through a work-centered interface tailored to individual needs and responsive to changes in a work domain. Certain embodiments introduce an adaptive, work-centered user interface technology software architecture, which embodies two novel concepts. The first concept is to use an ontology modeling approach to characterize a work domain in terms of “work-centered” activities as well as computation mechanisms to achieve an implementation that supports those activities. The second concept is to provide adaptive interaction, both user directed and automated, in work-centered characterization and presentation mechanisms of the user interface to enterprise-level applications.

Healthcare information systems are most effective when users are able to find and make use of relevant information across a timeline of patient care. An adaptive user interface can leverage semantic technology to model domain concepts, user roles and tasks, and information relationships, for example. Semantic models enable applications to find, organize and present information to users more effectively based on contextual information about the user and task.

In an example, a new level of adaptive user interface design is achieved by taking advantage of semantic Web technology. Domain concepts and relationships are characterized in a hierarchy of ontologies, associated with upper level ontological constructs that enable adaptive reasoning and extensibility.

Thus, certain embodiments offer adaptive user interface capabilities through use of a controller that can “reason” about metadata in an ontology to present users with a work-centered application tailored to individual needs and responsive to changes in a work domain. Targeted information can be delivered from “external” data in an application context-sensitive manner

In human-computer interaction, user interface data, events, and frequencies can be displayed, recorded, and organized into episodes. By computing data positioning on the screen, episode frequencies, and implication relations, certain example embodiments can automatically derive application-specific episode associations and therefore enable an application interface to adaptively provide just-in-time assistance to a user. By identifying issues related to designing an adaptive user interface, including interaction tracking, episodes identification, user pattern recognition, user intention prediction, and user profile update, an interface is generated that can act on a user's behalf to interact with an application based on certain recognized plans. To adapt to different users' needs, the interface can personalize its assistance by learning user profiles and disease-specific workflows, for example.

In certain embodiments, an adaptive user interface system includes a search engine, a Web server, an active listener, an information composition engine, a query engine, a data aggregator, a document summarizer, a profile context manager, and clinical and administrative dashboards, for example. Certain embodiments offer a complete view of an entire patient medical record in a user-specific, role-specific, disease-specific manner. In certain embodiments, a user interface can also be configured to provide operation views of data, financial views of data, and also serve as a dashboard for any type of data aggregation.

A work-centered solution helps provide an integrated and tailored system that offers support to work in a flexible and adaptable manner by customizing user interaction according to the situated context in which work is accomplished. Under a work-centered approach, an understanding of the overall targeted work domain is developed. For example, questions used to develop an understanding of the work domain can include what the work domain encompasses, what the goals of work are, who participates in the work domain, and how the participants achieve the goals of the work domain, given a local context. The understanding of the work domain can be used to characterize and, thus, support participants' day-to-day activities.

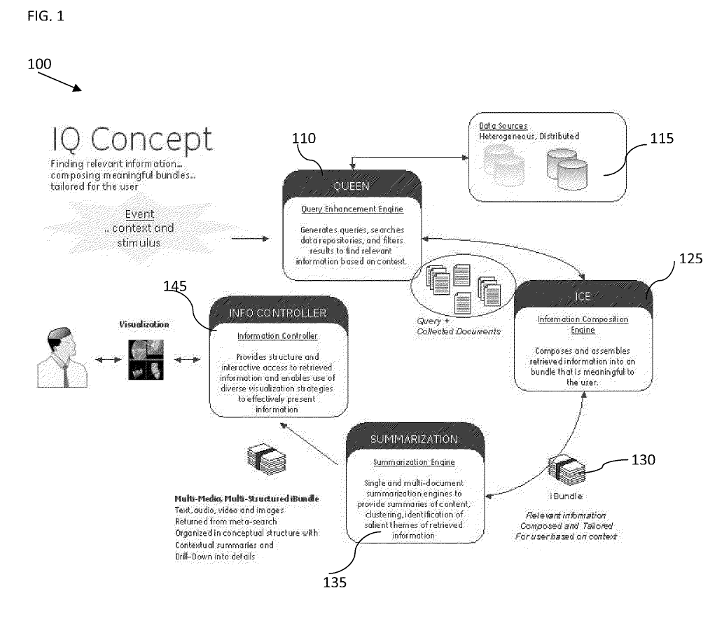

FIG. 1 illustrates an information composition and query enhancement (“IQ”) architecture 100 in accordance with an embodiment of the present invention. The IQ architecture 100 is an information architecture designed to support retrieval, composition (e.g., bundling), and presentation of information from multiple, heterogeneous data sources 115. The architecture 100 includes a query enhancement engine (“QUEEN”) 110 and an information composition engine (“ICE”) 125. The ICE-QUEEN architecture 100 provides a framework for finding relevant information and assembling the retrieved information into a bundle 130 that can be presented to a user. Applications interact with components of the IQ architecture 100s through an information controller 145. During the bundling of the retrieved information, information can be summarized using a summarization engine 135.

Information and data can be represented in a variety of formats, text (e.g., reports and papers), tables (e.g., databases), images (e.g., x-ray and computer-aided tomography (“CAT”) scans), and video (e.g., surgical procedures). Furthermore, the information and data often reside on different machines and stored (or computed) in a heterogeneous environment.

The query enhancement engine 110 retrieves information from disparate information sources 115 based on an information request (e.g., a stimulus) and a context 105. First, based on the original query and context 105, QUEEN 110 determines which information sources 115 are more appropriate for retrieving the requested information.

Once candidate sources 115 have been identified, a query is generated and passed to the information source 115 for retrieval. Different data repositories 115 (e.g., file systems, databases, etc.) utilize different mechanisms for retrieving data contained within them. QUEEN 110 encapsulates and utilizes an appropriate mechanism when interacting with each information source 115.

To improve precision of retrieval results, it is sometimes beneficial to modify the query prior to retrieval. Query enhancement can involve adding additional terms to a query to improve results. Query refinement can involve removing or substituting terms to a query to improve performance. QUEEN 110 can request information using an initial query, but then enhance or refine the query to improve performance, for example.

For a given information query or request, several different types of information may be desired for a particular task at hand to form a semantically meaningful bundle of information 130. The bundle 130 includes one or more types of information (e.g., patient history and lab results). Organizing the various informational items into semantic units is referred to as information composition or bundling.

The information composition engine 125 composes retrieved information together into a bundle 130 that is meaningful to a user. Bundles 130 can be composed based on the semantic needs of the user, and may also be driven by user preferences, and/or other knowledge appropriate to the domain, for example. ICE 125 employs composition decision logic (“CDL”) to compose the information. Some examples of CDL include aggregation, eliminating redundant information, lightweight summarization of information, and fusion of results, for example.

The multi-document summarizer of the summarization engine 135 creates a summary of a collection of documents 130 using a process combining natural language processing (“NLP”) and information retrieval (“IR”) techniques, for example. The process includes three primary steps: 1) segmentation; 2) clustering and classification; and 3) summary generation.

In segmentation, documents are segmented into passages (e.g., paragraphs).

In clustering/classification, passages are grouped into clusters based on a similarity metric. The similarity of two passages is computed by calculating a weight based on similar strings of words (called N-grams) found in the two passages. The metric produces a score between 0 and 1 similar to a cosine function. That is, the more similar the passages, the closer the score approaches a value of one. Similarity scores are computed for all pairs of passages using the metric. Once similarity scores are computed, pairs of passages can be placed in clusters. It is computationally expensive, however, to look at all combinations when there are many passages. Therefore, in certain embodiments, clustering is performed in two primary steps: 1) seed clustering and 2) classification. In seed clustering, a complete-link algorithm is used until a target number of clusters are found. The target number of clusters is equal to a logarithm of the number of documents 130. In classification, remaining passages are classified by finding a best matching seed cluster. If a passage has no similarity, it is placed in a trash cluster.

In summary generation, a most characteristic paragraph is then taken from each cluster to form a “meta document.” The single document summarizer (see below) is then used to create a “summary” for the entire collection 130.

In certain embodiments, the single document summarizer exploits an empirical observation that much of written text displays certain regularities of organization or style referred to as a discourse macro structure (“DMS”). In DMS, for example, a scientific paper may be organized into sections: Introduction, Methodology, Results, Discussion, and Conclusion. News articles are often presented with Background, and What-is-the-news. Using surface level (e.g., shallow) natural language processing techniques, continuous well-formed passages are selected from a source document and assembled to form a summary based on a DMS template. Because the summary is formed from passages selected from the document, highly readable and coherent summaries can be generated. Certain embodiments generate summaries attempting to balance between text compression and content preservation.

The single-document summarizer first segments text into passages or equal-sized chunks. Adjacent passages that are strongly linked to one another are reconnected. Passages are scored with respect to a query derived from the title, topic description, and terms occurring frequently in the text, for example. Scores are then normalized by a length of the passage. Passages are combined into groups of two or more and re-scored, until a clear winning passage or passage group emerges to form the summary.

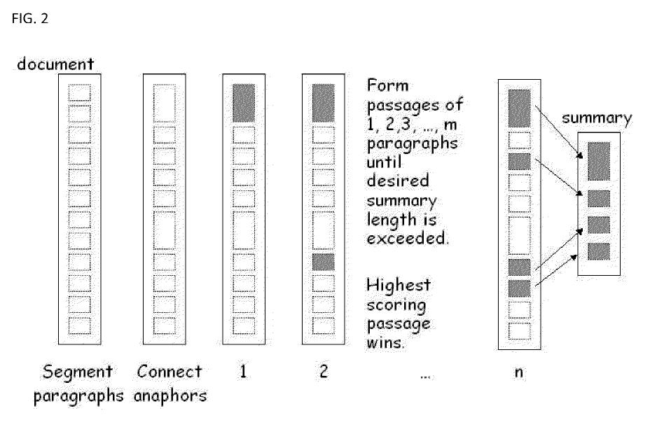

An example summarization algorithm is depicted in FIG. 2. As shown in FIG. 2, a goal is to keep the summary length as close to a target length as possible. A weighting formula is designed so that small deviations from the target length are acceptable, but large deviations will rapidly decrease the passage score. The example formulae below can be used when scoring a passage P of length 1 against a passage search query Q and target summary length t. The set of equations (1) illustrate a weighting scheme for a single document summarizer, for example:

$$RawScore ( Q , P ) = {\sum }_{q} w ( q , p ) + prem ( P ) \\ NormScore ( Q , P ) = \frac{RawScore ( Q , P )}{\sqrt{( 1 + t ) / t + 1}} , \qquad ( Eq . 1 )$$

where w(q,p)=1 if q is a member of P and is otherwise 0, and where prem(P)=a non-content based score premium.

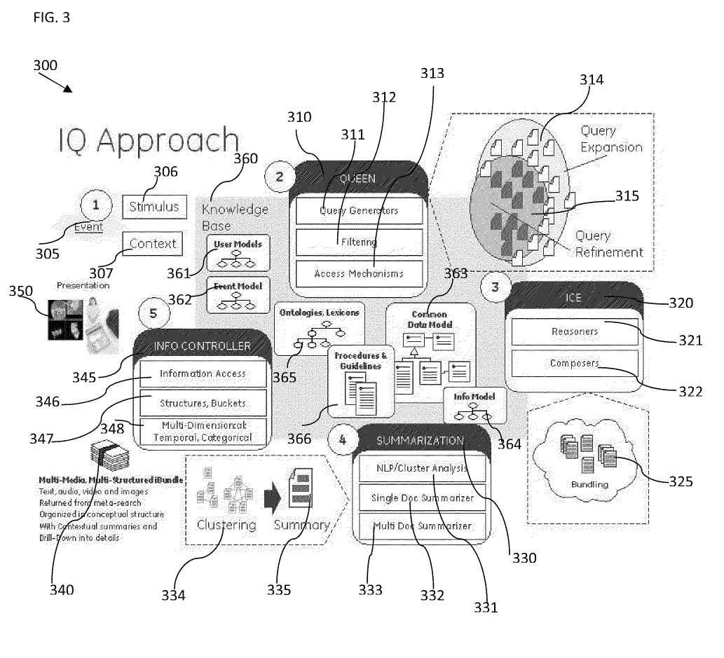

FIG. 3 provides a system 300 of underlying technologies used for each of the IQ components. As illustrated in FIG. 3, an event 305 including a stimulus 306 and a context 307 is transmitted to a QUEEN 310, which includes one or more query generators 311, filter(s) 312, and access mechanism(s) 313. Using the QUEEN 310, query expansion 314 and query refinement 315 can occur. Query results are passed to an ICE 320, which includes one or more reasoners 321 and composer(s) 322 to provide bundled documents 325. Bundled results 325 are provided to a summarization engine 330, which includes a NLP/cluster analysis engine 331, a single document summarizer 332, and a multi-document summarizer 333. The summarization engine 330 performs clustering 334 of the bundled documents 325 and generates a summary 335 based on the clustering 334. The summarization engine 330 provides a multi-media, multi-structural bundle of information 340 based on the bundled documents 325 and summary information 335. An information controller 345, including an information access engine 346, one or more structures/buckets 347, and multi-dimensional identification 348 (e.g., temporal, categorical, etc.), regulates information exchange and provides the bundle 340 in a presentation 350 to a user. Actions of the QUEEN 310, ICE 320, summarization engine 330, and information controller 345 are facilitated using a knowledge base 360 of models (such as one or more user models 361, event model 362, common data model 363, information model 364, etc.), ontologies and lexicons 365, procedures and guidelines 366, etc.

As an example of operation, prior to performing surgery on a patient, a physician wants to know the patient's allergies. Information regarding a patient's allergies can be stored in different systems using a combination of document repositories, file systems, and databases, for example. Using an ICE-QUEEN engine, a variety of information about the patent's allergies is found and bundled and presented to the physician. Some of the information may be buried within paragraphs in some documents, while other information is found in databases tables. When a system's databases have been exposed (e.g., through a connection framework), the ICE-QUEEN engine can connect to the database to query for information. When a database is not available for a particular system, the document repository for that system can still be searched. The document summarizer can be used to provide summaries of documents retrieved and to cluster related passages from documents retrieved to pull in related patient information. The information is organized into a bundle before being delivered to the user. The information can be organized based on information type, semantics, information relevance, and the confidence score from the underlying repository.

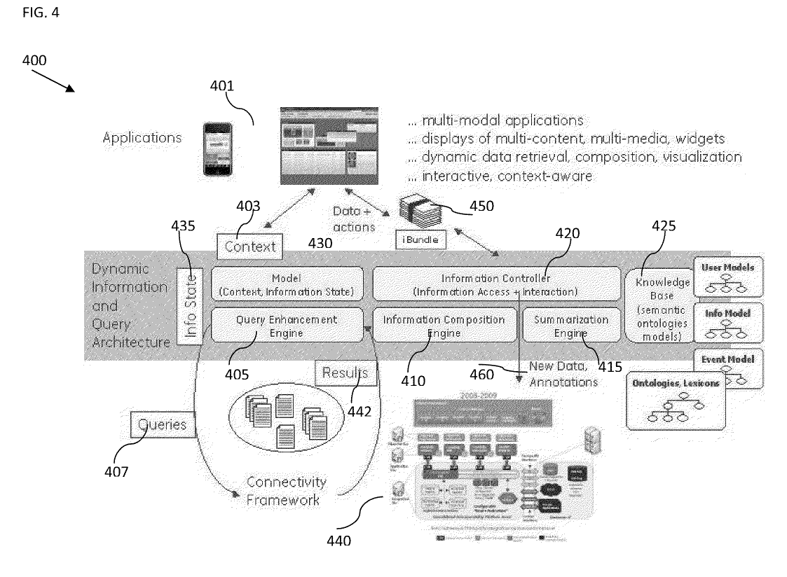

As illustrated, for example, in FIG. 4, an information architecture 400 is provided to support retrieval, composition (e.g., bundling), and presentation of information from multiple, heterogeneous data sources. Components of the architecture 400 include a query enhancement engine 405, an information composition engine 410, a summarization engine 415, an information controller 420, a knowledge base 425, a model 430, and an information state 435.

The query enhancement engine 405 generates queries, searches data repositories, and filters results to find relevant information based on a context 403. The information composition engine 410 composes and assembles retrieved information into an information bundle that is organized as relevant to a user. The summarization engine 415 includes single and multi-document summarization engines to provide summaries of content, clustering, and identification of salient themes of retrieved information. The information controller 420 provides structure and interactive access to retrieved information and enables use of diverse visualization strategies to more effectively present invention. The knowledge base 425 provides models (e.g., user models, information models, event models, ontologies, lexicons, etc.) for users, events, and information to enable utilization of semantic relationships.

FIG. 4 illustrates a high-level view of these technologies integrated with a user interface system to improve the retrieval of relevant information, compose the collected information into meaningful information bundles 450, and display the information to the user for a particular context 403. One or more applications 401 for querying and displaying and/or otherwise processing results can be either thick clients that run on a personal computer/workstation or mobile-applications running on a handheld or other mobile device (e.g., a personal digital assistant or cellular phone). These applications 401 can be composed, for example, by assembling multiple information widgets which can display different kinds of data. For example, one widget may be used to display textual information summarizing patient medications, while another widget may enable x-ray (e.g., images) or ultrasound (e.g., video) to be displayed. Other widgets may enable the display of data among different dimensions, such as time, and allow the user to interact with the data to drill-down into more detail, for example.

The information architecture 400 provides mechanisms for applications 401 to retrieve information from disparate data sources and provide that data to applications 401 in a structured way to enable meaningful information display to the user. Information widgets interact with the architecture 400 via the information controller 420. Via the controller 420, the application 401 can provide context 403 about the user (e.g., role and preferences) and the underlying event (e.g., patient stroke workup). The controller 420 can provide this information to the query enhancement engine 405 to identify data sources and retrieve the most relevant information via one or more queries 407 of a connectivity framework 440 to provide results 442. The retrieved information is then examined by the information composition engine 410 for bundling and composition. Some information can be summarized by the summarization engine 415 before the information bundle (or i-bundle) 450 is returned to the application 401 for presentation.

The knowledge base 425 contains models of roles, users, events, and information as well as medical ontologies. These semantic concepts are available to other components, such as the query enhancement engine 405 or the information composition engine 410 to improve the retrieval and bundling of information for the user.

For some applications 401, it may be desirable for the user to enter new data or to annotate the data that has been retrieved. The information controller 420 provides mechanisms for making these data updates. For example, new data and/or other action 455 can be provided from the application 401 to the information controller 420 for future use. Alternatively or in addition, new data and/or annotations 460 can be provided via the information controller 420 to the connectivity framework 440.

Thus, semantic information can be shared and leveraged by components for use in retrieving information based on semantic concepts and relationships, organizing retrieved information based on semantic relationships, and showing relationships among information and data retrieved using semantic concepts and relationships. For example, a longitudinal temporal display of patient information can be improved by enabling the display of various relationships between data that is semantically related. Reasoning mechanisms can be integrated to enable information to be more effectively inserted into a workflow to enable more decision support at a point of patient care. Reasoning engines can be integrated to enable information to be dynamically delivered to users at different points during care of a patient.

Certain embodiments allow healthcare information systems to find and make use of relevant information across a timeline of patient care. For example, a search-driven, role-based interface allows an end user to access, input, and search medical information seamlessly across a healthcare network. An adaptive user interface provides capabilities through a work-centered interface tailored to individual needs and responsive to changes in a work domain, for example. Semantic technology can be leveraged to model domain concepts, user roles and tasks, and information relationships. The semantic models enable applications to find, organize and present information to users more effectively based on contextual information about the user and task. Components forming a framework for query and result generation include user interface frameworks/components for building applications; server components to enable more efficient retrieval, aggregation, and composition of information based on semantic information and context; and data access mechanisms for connecting to heterogeneous information sources in a distributed environment.

A variety of user interface frameworks and technologies can be used to build applications including, Microsoft® ASP.NET, Ajax®, Microsoft® Windows Presentation Foundation, Google® Web Toolkit, Microsoft® Silverlight, Adobe®, and others. Applications can be composed from libraries of information widgets to display multi-content and multi-media information, for example. In addition, the framework enables users to tailor layout of the widgets and interact with underlying data.

Healthcare information can be distributed among multiple applications using a variety of database and storage technologies and data formats. To provide a common interface and access to data residing across these applications, a connectivity framework (“CF”) is provided which leverages common data and service models (“CDM” and “CSM”) and service oriented technologies, such as an enterprise service bus (“ESB”) to provide access to the data.

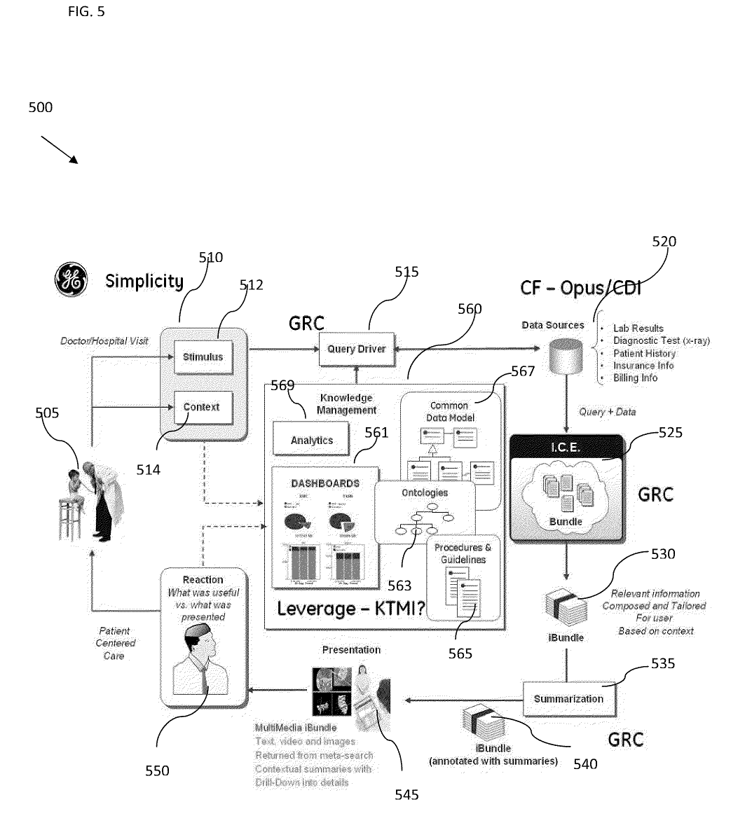

FIG. 5 illustrates a workflow 500 for providing adaptive, work-centered healthcare services in accordance with certain embodiments of the present invention. The workflow 500 includes a patient visit 505 to a doctor, hospital, clinic, etc. From the patient visit 505, a query 510 is generated by a clinician such as an examining physician, a nurse, etc. The query 510 can include a stimulus 512 observed and a patient context 514, for example. The query 510 is passed to a query driver 515. The query driver 515 can query one or more data source 520 and/or a knowledge management subsystem 560, for example. Data source(s) 520 can include one or more of lab results, diagnostic tests (e.g., x-ray, magnetic resonance image, ultrasound, etc.), patient history, insurance information, billing information, etc.

In certain embodiments, the query driver 515 can include and/or be in communication with a Query Enhancement Engine (“QUEEN”). Information may be represented in a plurality of formats including text (e.g., reports and papers), tables (e.g., databases), images (e.g., x-ray and computed tomography scans), and video (e.g., surgical procedures). Furthermore, information often reside on different systems and are stored and/or computed in a heterogeneous environment.

The Query Enhancement Engine can be used for retrieving information from disparate information sources 520 based on an information need (e.g., a stimulus 112) and a context 514. First, based on the original query 510 and context 514, QUEEN determines which information source(s) 520 are most appropriate for retrieving the requested information by consulting an information registry.

Once candidate information source(s) 520 have been identified, the query 510 is generated (by the Query Enhancement Engine 515) and passed to the information source 520 for retrieval. Different data repositories (file systems, databases, etc) utilize different mechanisms for retrieving data within them. The information source 520 encapsulates these retrieval mechanisms.

An information controller can be used to manage interaction between the query enhancement engine 515 and the information composition engine 525. When the QUEEN 515 has retrieved all of the information, the information is passed to the information composition engine 525 for composition and bundling before being delivered to an application or user.

To improve the precision of retrieval results, it is sometimes beneficial to modify the query prior to retrieval. Query enhancement may involve adding additional terms to a query to improve results. Query refinement may involve removing or substituting terms to a query to improve performance. The QUEEN 515 may request information using an initial query and then enhance or refine the query to improve performance, for example.

The query 510 is combined with data from the one or more data source 520 and provided to an information composition engine (“ICE”) 525 to compile or bundle data from the data source(s) 520 in response to the query 510. The ICE 525 can bundle information for presentation from multiple, heterogenous data sources 520.

For example, for a given information need, several different types of information may be desirable for the particular task at hand to form a semantically meaningful bundle of information. A bundle includes one or more types of information (e.g., patient history and lab results). Organizing the various informational items into semantic units is referred to as information composition or bundling. The ICE 525 is responsible for composing the retrieved information from the data source(s) 520 together into a bundle that is meaningful to the user. Bundles may be composed based on the semantic needs of the user, and may also be driven by user preferences, and/or other knowledge appropriate to the domain, for example.

In certain embodiments, the ICE 525 uses Composers to compose the information retrieved from the data source(s) 520. Composers employ Composition Decision Logic (“CDL”), for example, to compose the information. Some examples of CDL include aggregation elimination of redundant information, lightweight summarization of information, and fusion of results, for example.

In certain embodiments, during composition, it may be determined that some information is missing or insufficient information. In this case, the ICE 525 may inform the information controller that information is missing. The information controller can then inform the QUEEN 515 that one or more queries need to be enhanced or refined in order to improve retrieval performance. The queries are performed again and the results are passed back to the ICE 525 for composition and bundling prior to being returned to the user.

The ICE 525 then produces a bundle 530 including relevant information composed and tailored for a requesting user based on context information 514 from the query 510. The bundle 530 is passed to the summarization engine 535. The summarization engine 535 provides multi-document summarization for the content of the bundle 530. Summarization will be described further below.

A revised bundle 540, annotated with summaries from the summarization engine 535, is used to generate a presentation 545. The presentation can include a multimedia bundle of text, video and images returned from a metadata search of the data source(s) 520 and including contextual summaries from the summarization engine 535. A user can drill down into details through the presentation 545. A user, such as a physician and/or nurse, can use information from the presentation 545 to further diagnose and/or treat the patient. A user's reaction and/or other feedback 550 from the presentation 545 information can be provided back to the knowledge management subsystem 560 for subsequent use.

The knowledge management subsystem 560 will now be described in further detail. The knowledge management subsystem 560 includes one or more tools and/or additional information to assist the query driver 515 to form a query to extract relevant information from the data source(s) 520. Query 510 information, such as stimulus 512 and context 514, can be input to the knowledge management subsystem 560 to provide relevant tools and/or information for the query driver 515. Alternatively and/or in addition, clinician reaction and/or other feedback 550 can be fed back into the subsystem 560 to provide further information and/or improve further results from the knowledge management subsystem 560.

As shown, for example, in FIG. 5, the knowledge management subsystem 560 includes one or more dashboards 561, one or more ontologies 563, procedures and guidelines 565, a common data model 567, and analytics 569. The knowledge management subsystem 560 can provide a Knowledge and Terminology Management Infrastructure (“KTMI”) to the workflow 500. An ontology 563 details a formal representation of a set of concepts within a domain and the relationships between those concepts. The ontology 563 can be used to define a domain and evaluate properties of that domain. The common data model 567 defines relationships between disparate data entities within a particular environment and establishes a context within which the data entities have meaning. The common data model 567 provides a data model that spans applications and data sources in the workflow 500 and defines data relationships and meanings within the workflow 500. Using the analytics 569, for example, the subsystem 560 can access dashboard(s) content 561, ontology(ies) 563, and procedures/guidelines 565 based on a common data model 567 to provide output to the query driver 515.

The activity of summarization engine 535 will now be described in further detail. Multi-document summarization is an automatic procedure aimed at extraction of information from multiple texts written about the same topic (e.g., disease across multiple patients). A resulting summary report allows individual users, such as examining physicians, nurses, etc., to quickly familiarize themselves with information included in a large cluster of documents. Thus, the summarization engine 535 can complement the ICE 525 to summarize and annotate content for ease of reference, for example.

Multi-document summarization creates information reports that are more concise and comprehensive than a review of the raw data. Different opinions are put together and outlined to describe topics from multiple perspectives within a single document. While a goal of a brief summary is to simplify an information search and reduce time by pointing to the most relevant source documents, a comprehensive multi-document summary should itself contain the requested information, hence limiting the need for accessing original files to cases when refinement is required. Automatic summaries present information extracted from multiple sources algorithmically, without any editorial touch or subjective human intervention, in an attempt to provide unbiased results.

However, multi-document summarization is often more complex than summarizing a single document due to thematic diversity within a large set of documents. A summarization technology aims to combine the main document themes with completeness, readability, and conciseness. For example, evaluation criteria for multi-document summarization developed through Document Understanding Conferences, conducted annually by the National Institute of Standards and Technology, can be used.

In certain embodiments, the summarization engine 535 does not simply shorten source texts but presents information organized around key aspects of the source texts to represent a wider diversity of views on a given topic. When such quality is achieved, an automatic multi-document summary can be used more like an overview of a given topic.

Multi-document summary criteria can include one or more of the following: a clear structure, including an outline of the main content, from which it is easy to navigate to full text sections; text within sections is divided into meaningful paragraphs; a gradual transition from more general to more specific thematic aspects; good readability; etc. with respect to good readability, the automatic overview can show, for example, no paper-unrelated “information noise” from the respective documents (e.g., web pages); no dangling references to subject matter not mentioned or explained in the overview; no text breaks across a sentence; no semantic redundancy; etc.

In certain embodiments, a summarization approach includes three steps: 1) segmentation, 2) clustering/classification, and 3) summary generation. An initial text segmentation is performed by dividing or “chunking” a document into paragraphs based on existing paragraph boundaries. Subtitles and one-line paragraphs can be merged, for example. When no paragraph boundaries are present, then chunking can be done by dividing after ever N words (e.g., every 20 words), for example.

For clustering, one or more natural language processing (“NLP”) techniques can be applied to measure similarity between two collections of words, for example. For example, paragraphs including similar strings of words (e.g., N-grams) are identified, and a similarity metric is defined to determine whether two passages are similar. For example, a similarity metric can provide an output resembling a cosine function (e.g., results closer to a value of one indicate greater similarity). Passage similarity scores can be computed for all pairs of passages using these metrics.

In certain embodiments, it is computationally expensive to look at all combinations of clusters when there are many passages. Therefore, clustering can be performed in two steps: seed clustering and classification. In seed clustering, a complete-link algorithm can be used until a target number of clusters are found. For example, a target number of clusters can be equal to log(number of documents). In classification, remaining passages are then classified by finding a best matching seed cluster. If a passage has no similarity, it is placed in a trash cluster.

For summary generation, a most characteristic paragraph is then taken from each cluster to form a “meta document.” A single document summarizer is then used to create a “summary” for the entire collection. The summary is bundled with the information and provided as the bundle 540.

As an example of the workflow 500 in action, suppose that, prior to performing surgery on a patient, a physician wants to know what allergies a patient has. Information about a patient's allergies may be stored in different systems using a combination of document repositories, file systems, and databases 520. Using the ICE 525, a variety of information about the patent's allergies is found and bundled and presented to the physician. Some of the information may be buried within paragraphs in some documents, while other information is found in database tables, for example. When a system's databases have been exposed (e.g., through a Connectivity Framework), the ICE 525 and its QUEEN 515 can connect to the database 520 to query for information. When a database is not available for a particular system, the document repository for that system can still be searched. The document summarizer 535 can be used to provide summaries of documents retrieved and to cluster related passages from documents retrieved to pull in related patient information. The information is organized into a bundle 540 before being delivered to the user. The information may be organized based on information type, semantics, information relevance, and the confidence score from the underlying repository, for example.

In certain embodiments, the workflow 500 supports a user by continually searching for relevant information from connectivity framework components using a query generation engine 515. Subsequently, these results are classified and bundled through an information composition engine 525 that transforms the information for appropriate presentation to the user.

In certain embodiment, an adaptive user interface (“UI”) design is achieved by taking advantage of semantic web technology. For example, domain concepts and relationships are characterized in a hierarchy of ontologies, associated with upper level ontological constructs that enable adaptive reasoning and extensibility.

A core ontology can be derived from one or more work-centered design principles. For example, an effective interface can display information that represents a perspective that a user needs on a situated work domain to solve particular types of problems. As another example, information that is the most important to the user in the current work context can be displayed in a focal area to engage the user's attention. Referential information can be offered in a periphery of a display to preserve context and support work management. As a further example, a user's own work ontology (e.g., terms and meaning) should be the primary source for information elements in the interface display.

Thus, certain embodiments provide adaptive user interface capabilities through use of a controller that can “reason” about metadata in an ontology to present users with a work-centered application tailored to individual needs and responsive to changes in the work domain. Such user interface capabilities help obviate problems associated with browsing “external” data that a connectivity framework can access by offering an interface to deliver targeted information in an application context-sensitive manner.

In human-computer interaction, user interface data, events, and frequencies can be displayed, recorded, and organized into episodes. By computing data positioned on a display screen, episode frequencies, and implication relations, application-specific episode associations can be automatically derived to enable an application interface to adaptively provide just-in-time assistance to a user. By identifying issues related to designing an adaptive user interface, including interaction tracking, episodes identification, user pattern recognition, user intention prediction, and user profile update, for example, the interface can act on a user's behalf to interact with an application based on certain recognized plans. To adapt to different users' needs, the interface can personalize its assistance by learning user profiles and disease-specific workflows, for example.

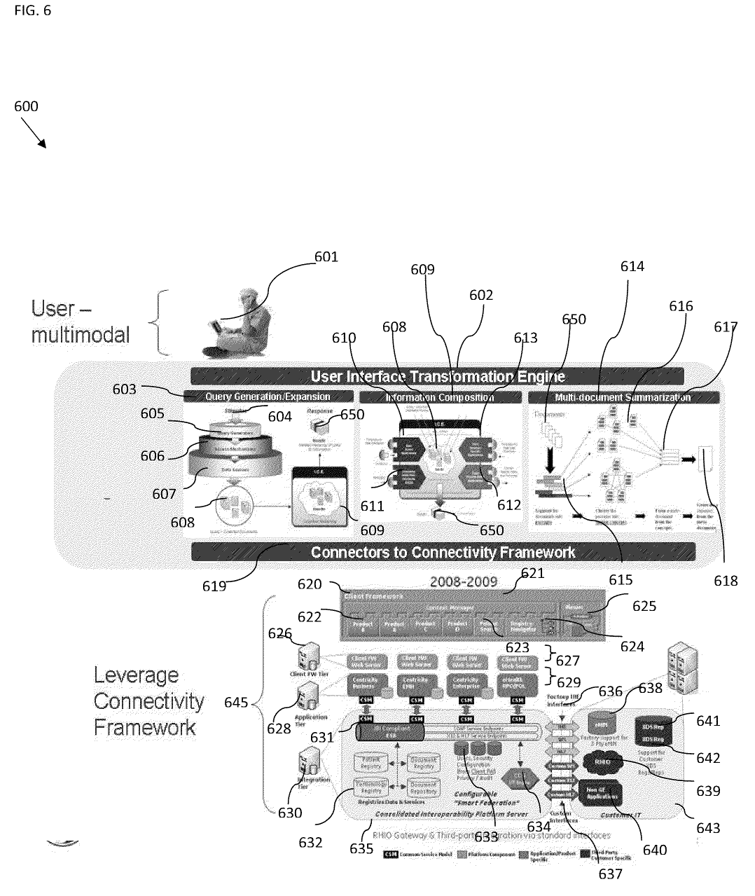

FIG. 6 depicts a user interface architecture 600 in accordance with certain embodiments of the present invention. The architecture 600 includes a user interface transformation engine 602, a query generation/expansion engine 603, an information composition engine 609, a multi-document summarization engine 614, and one or more connectors 619 to a connectivity framework 645. The components of the architecture 600 are accessible by a user via a user interface 601 on a processing device, such as a computer or handheld device. The user can submit a query for information via the user interface 601, for example.

The query generation/expansion engine 603 includes a stimulus 604, one or more query generators 605, and one or more access mechanisms 606 to search one or more data source 607 to produce a query and collected documents 608. The query and collected documents 608 are passed to the information composition engine 609 that includes applications 610, 611, 612, 613 that process and apply cognitive reasoning, for example, to organize the query and collected documents 608 into one or more units meaningful to a requesting user based on one or more of semantic guidelines, user preferences, and domain-related information, for example. A toolset including composers can employ Composition Decision Logic (“CDL”), such as aggregation, elimination of redundant information, lightweight summarization of information, and fusion of results, to compose the information. Applications can include one or more data driven applications 610, enterprise application interfaces 611, task/process driven applications 612, and data structure specific applications 613, for example. The applications 610, 611, 612, and/or 613 can include one or more templates related to new data types, new data structures, domain specific tasks/processes, new application interfaces, etc. Composition and processing of the query and collected documents 608 produces a bundle 650 of information in response to a user query.

The multi-document summarization engine 614 receives the bundle 650 of documents and segments the documents into passages 615. The passages 615 are clustered based on similar concepts 616. A meta-document 617 is then formed from the concepts 616. A summary 618 is generated from the meta-document 617. Query results 650, the meta-document 617, and/or the meta-document summary 618 can be provided to the user via the user interface 601.

Via connectors 619 to a connectivity framework 645, the user interface 601 and its engines 603, 609, 614 can send and receive information in response to user query via the interface 601, for example. For example, the query engine 603 can access the connectivity framework 645 to query one or more data sources 607.

The connectivity framework 645 includes a client framework 620. The client framework 620 includes a context manager 621 for one or more products 622, a patient search 623, a registry navigator 624, and a viewer 625. Thus, in certain embodiments, the connectivity framework 620 can facilitate viewing and access to information via the user interface 601 and apart from the user interface 601. Via the connectivity framework 645, the query engine 603 and/or other parts of the user interface 601 can access information and/or services through a plurality of tiers.

Tiers can include a client framework tier 626, an application tier 628, and an integration tier 630, for example. The client framework tier 626 includes one or more client web servers 627 facilitating input and output of information, for example. The applicant tier 628 includes one or more applications 629 related to enterprise and/or departmental usage such as business applications, electronic medical records, enterprise applications, electronic health portal, etc. The integration tier 630 includes a consolidated interoperability platform server 635 in communication with customer information technology (“IT”) 643 via one or more factory 636 and/or custom 637 interfaces, such as default and/or customized interfaces using a variety of message formats such as a web service (“WS”), X12, Health Level Seven (“HL7”), etc. The consolidated interoperability platform 635 can communicate with the one or more applications 629 in the application tier 628 via a common service model (“CSM”), for example.

As shown, for example, in FIG. 6, the consolidated interoperability platform 635 includes an enterprise service bus (“ESB”) 631, a collection of registries, data, and services 632, configuration information 633, and a clinical content gateway (“CCG”) interface engine 634, for example. The ESB 631 can be a Java business intelligence (“JBI”) compliant ESB, for example. The ESB 631 can include one or more endpoints or locations for accessing a Web service using a particular protocol/data format, such as X12, HL7, SOAP (simple object access protocol), etc., to transmit messages and/or other data, for example. Using a CSM, the ESB 631 facilitates communication with the applications 629 in the application tier 628, for example. Via the ESB 631, information in the registries, data and services repository 632 can be provided to the applicant tier 631 in response to a query, for example. Configuration information 633 can be used to specify one or more parameters such as authorized users, levels of authorization for individual users and/or groups/types of users, security configuration information, privacy settings, audit information, etc. The CCG interface engine 631 receives data from the customer IT framework 643 and provides the data to the registries 632 and/or applications 629 in the application tier 631, for example.

As shown, for example, in FIG. 6, the customer IT 643 includes support for a third party electronic message passing interface (“eMPI”) 638, support for a regional health information organization (“RHIO”) 639, one or more third party applications 640, support for a cross-enterprise document sharing (“XDS”) repository 641, support for an XDS registry 642, and the like. Using customer IT 643 in conjunction with the interoperability platform 635, a RHIO gateway and third party application integration can be provided via one or more interfaces to the connectivity framework 645 and/or the query generation/expansion engine 603 of the user interface 601.

The customer IT framework 643 can be organized to provide storage, access and searchability of healthcare information across a plurality of organizations. The customer IT framework 643 may service a community, a region, a nation, a group of related healthcare institutions, etc. For example, the customer IT framework 643 can be implemented with the RHIO 639, a national health information network (“NHIN”), a medical quality improvement consortium (“MQIC”), etc. In certain embodiments, the customer IT 643 connects healthcare information systems and helps make them interoperable in a secure, sustainable, and standards-based manner.

In certain embodiments, the customer IT framework 643 provides a technical architecture, web applications, a data repository including EMR capability and a population-based clinical quality reporting system, for example. The architecture includes components for document storage, querying, and connectivity, such as the XDS registry 642 and repository 641. In certain embodiments, the XDS registry 642 and repository 641 can include an option for a subscription-based EMR for physicians, for example. In certain embodiments, the XDS registry 642 and repository 641 are implemented as a database or other data store adapted to store patient medical record data and associated audit logs in encrypted form, accessible to a patient as well as authorized medical clinics. In an embodiment, the XDS registry 642 and repository 641 can be implemented as a server or a group of servers. The XDS registry 642 and repository 641 can also be one server or group of servers that is connected to other servers or groups of servers at separate physical locations. The XDS registry 642 and repository 641 can represent single units, separate units, or groups of units in separate forms and may be implemented in hardware and/or in software. The XDS registry 642 and repository 641 can receive medical information from a plurality of sources.

Using an XDS standard, for example, in the customer IT framework 643, document querying and storage can be integrated for more efficient and uniform information exchange. Using the customer IT 643, quality reporting and research may be integrated in and/or with an RHIO 639 and/or other environment. The customer IT 643 can provide a single-vendor integrated system that can integrate and adapt to other standards-based systems, for example.

Via the customer IT framework 643, a group of EMR users may agree to pool data at the XDS registry 642 and repository 641. The customer IT framework 643 can then provide the group with access to aggregated data for research, best practices for patient diagnosis and treatment, quality improvement tools, etc.

XDS provides registration, distribution, and access across healthcare enterprises to clinical documents forming a patient EMR. XDS provides support for storage, indexing, and query/retrieval of patient documents via a scalable architecture. Certain embodiments, however, support multiple affinity domains (defined as a group of healthcare enterprise systems that have agreed upon policies to share their medical content with each other via a common set of policies and a single registry) such that each affinity domain retains its autonomy as a separate affinity domain but shares one instance of hardware and software with the other involved affinity domains. The XDS registry 642 and repository 641 can maintain an affinity domain relationship table used to describe clinical systems participating in each affinity domain. Once a request for a document is made, the source of the request is known and is used to determine which document(s) in the repository 641 are exposed to the requesting user, thus maintaining the autonomy of the affinity domain.

In certain embodiments, the XDS registry 642 and repository 641 represent a central database for storing encrypted update-transactions for patient medical records, including usage history. In an embodiment, the XDS registry 642 and repository 641 also store patient medical records. The XDS registry 642 and repository 641 store and control access to encrypted information. In an embodiment, medical records can be stored without using logic structures specific to medical records. In such a manner the XDS registry 642 and repository 641 is not searchable. For example, a patient's data can be encrypted with a unique patient-owned key at the source of the data. The data is then uploaded to the XDS registry 642 and repository 641. The patient's data can be downloaded to, for example, a computer unit and decrypted locally with the encryption key. In an embodiment, accessing software, for example software used by the patient and software used by the medical clinic performs the encryption/decryption.

In certain embodiments, the XDS registry 642 and repository 641 maintain a registration of patients and a registration of medical clinics. Medical clinics may be registered in the XDS registry 642 and repository 641 with name, address, and other identifying information. The medical clinics are issued an electronic key that is associated with a certificate. The medical clinics are also granted a security category. The security category is typically based on clinic type. In certain embodiments, the requests and data sent from medical clinics are digitally signed with the clinic's certificate and authenticated by the XDS registry 642 and repository 641. Patients may be registered in the XDS registry 642 and repository 641 with a patient identifier and password hash. Patients may also be registered in the XDS registry 642 and repository 641 with name, address, and other identifying information. Typically, registered patients are issued a token containing a unique patient identifier and encryption key. The token may be, for example, a magnetic card, a fob card, or some other equipment that may be used to identify the patient. A patient may access the XDS registry 642 and repository 641 utilizing their token, and, in an embodiment, a user identifier and password.

In certain embodiments, design of the user interface architecture 600 is guided by a plurality of factors related to the interactive nature of the system. For example, one factor is visibility of system status. The system can keep users informed about what is going on through appropriate feedback within reasonable time. Additionally, another factor is a match between the system and the “real world.” The system can speak the user's language, with words, phrases and concepts familiar to the user, rather than system-oriented terms. For example, information can follow real-world conventions and appear in a natural and logical order. Additionally, with respect to consistency and standards, users should not have to wonder whether different words, situations, or actions mean the same thing. The interface architecture can follow platform conventions, for example.

Another example factor relates to user control and freedom. Users often choose system functions by mistake and need a clearly marked “emergency exit” to leave the unwanted state without having to go through an extended dialogue. Certain embodiments support undo and redo operations related to configuration of system parameters and information query, for example.

Another factor is error prevention. Error-prone conditions can be eliminated, or the system can check for error conditions and present users with a confirmation option before a remedial action is executed. Additionally, certain embodiments can help users recognize, diagnose, and recover from errors. Error messages can be expressed in plain language (e.g., no codes), precisely indicate the problem, and constructively suggest a solution, for example. Even though it is better if the system can be used without documentation, it may be necessary to provide help and documentation. Any such information can be easy to search, focused on the user's task, list concrete steps to be carried out, and not be too large, for example.

With respect to ease of user interaction, the system can reduce or minimize the user's memory load by making objects, actions, and options visible. The user should not have to remember information from one part of the dialogue to another. Instructions for use of the system can be visible or easily retrievable whenever appropriate. Further, accelerators, often unseen by a novice user, can often speed up interaction for an expert user such that the system can cater to both inexperienced and experienced users. In certain embodiments, users can tailor frequent actions. Additionally, displayed dialogues can be configured not to include information that is irrelevant or rarely needed. Every extra unit of information in a dialogue competes with the relevant units of information and diminishes their relative visibility.

Certain embodiments provide visualization strategies with a graphical user interface for disparate data types across large clinical datasets across an enterprise. Thus, design elements can include, for example, institutional components, a single point of access search, one or more components/widgets, one or more medical records grids/forms, scheduling, clinical data results, graphs, task lists, messaging/collaboration components, multi-scale images (e.g., deep zoom), one or more external components, mail, RSS feeds, external Web-based clinical tools (e.g., WebMD), etc. Server components can include, for example, a search engine, a Web server, an active listener, an information composition engine, a query engine, a data aggregator, a document summarizer, profile context management, one or more dashboards (e.g., clinical and administrative), etc.

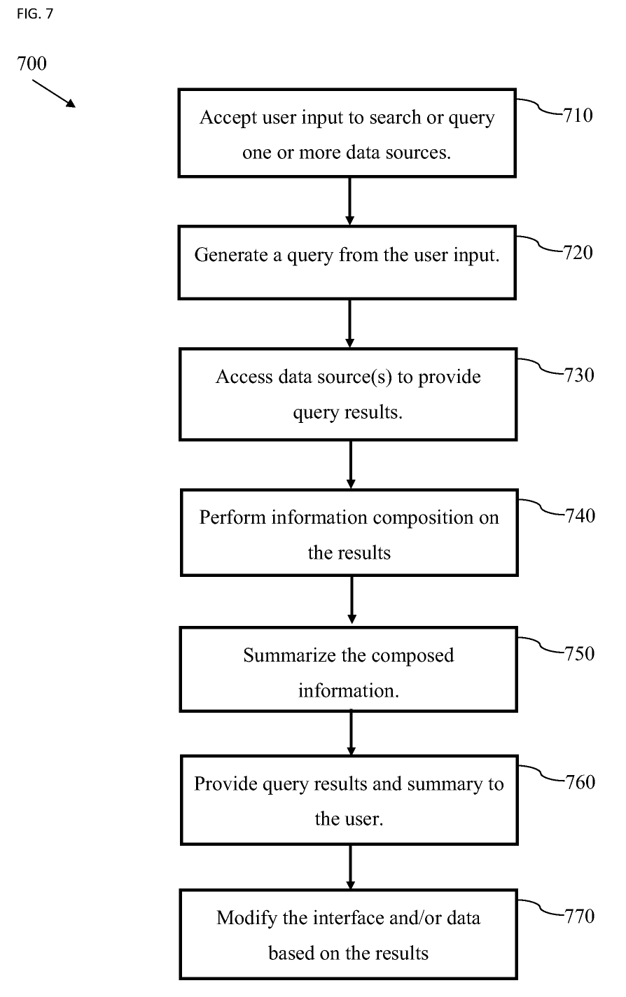

FIG. 7 shows a flow diagram for a method 700 for query generation and result composition in accordance with an embodiment of the present invention. At 710, user input is accepted to search or query one or more data sources. For example, user input can include a request for information about a patient, activation of a widget, positioning of information in a user interface display, etc. User input can include information regarding a patient encounter such as a stimulus and a context. User input can be automatically extracted from information requested and/or applications executed via a user interface.

At 720, a query is generated from the user input. The query can be used to search one or more data sources such as via a connectivity framework providing access to one or more systems, applications, registries, repositories, etc., for example. For example, a query engine can act on a stimulus and context from a patient encounter to search one or more data sources to produce one or more collected documents.

At 730, one or more data sources are accessed via a connectivity framework to provide query results. For example, an XDS registry and repository can be searched for information in response to the user's query about a stimulus and context from the patient encounter.

At 740, information composition is performed on the query results. For example, an information composition engine can process and apply reasoning to organize query results into one or more units for user review based on criteria including semantic guidelines, user preferences, domain information, etc. Techniques such as aggregation, elimination of redundant information, lightweight summarization of information, and fusion of results, for example, can be used to compose the information.

At 750, the composed information is summarized. For example, a document summarizer receives a composed set or bundle of information. The document summarizer segments the documents and clusters the segments based on identifying similar concepts, for example. Based on the concepts, a meta- or multi-document is formed, which is used to generate a summary.

At 760, query results and the related summary are provided to the user via the interface. For example, thumbnails, links, summaries, and/or other representations of data can be graphically provided to the user via the user interface. Selection of a thumbnail, link, summary, etc., may generate a further level of detail for review by the user and/or retrieval and display of source documents, for example.

At 770, modification of the user interface and/or data is allowed based on the results. For example, a user and/or application can display a new widget from a library on the interface based on results returned from a patient condition query. As another example, a new widget can be created from existing widget and query result information for use by the user via the interface. As another example, a user can select one or more query results to view further detail and/or related information via the interface.

One or more of the steps of the method 700 may be implemented alone or in combination in hardware, firmware, and/or as a set of instructions in software, for example. Certain examples may be provided as a set of instructions residing on a computer-readable medium, such as a memory, hard disk, DVD, or CD, for execution on a general purpose computer or other processing device.

Certain examples may omit one or more of these steps and/or perform the steps in a different order than the order listed. For example, some steps may not be performed in certain examples. As a further example, certain steps may be performed in a different temporal order, including simultaneously, than listed above.

Thus, certain embodiments provide a plurality of benefits including a single point of access, cross-modality data access, XDS compliance, push and pull capability, consensus building, transparency, knowledge management enhanced by use, cross platform (Web, mobile, etc.) accessibility, and a system level view of a user's information space, for example.

Certain embodiments provide an architecture and framework for a variety of clinical applications. The framework can include front-end components including but not limited to a Graphical User Interface (GUI) and can be a thin client and/or thick client system to varying degree, which some or all applications and processing running on a client workstation, on a server, and/or running partially on a client workstation and partially on a server, for example.

The example user interface systems and methods described herein can be used in conjunction with one or more clinical information systems, such as a hospital information system (“HIS”), a radiology information system (“RIS”), a picture archiving and communication system (“PACS”), a cardiovascular information system (“CVIS”), a library information system (“LIS”), an enterprise clinical information system (“ECIS”), an electronic medical record system (“EMR”), a laboratory results/order system, etc. Such systems can be implemented in software, hardware, and/or firmware, for example. In certain implementations, one or more of the systems can be implemented remotely via a thin client and/or downloadable software solution. Furthermore, one or more components can be combined and/or implemented together.

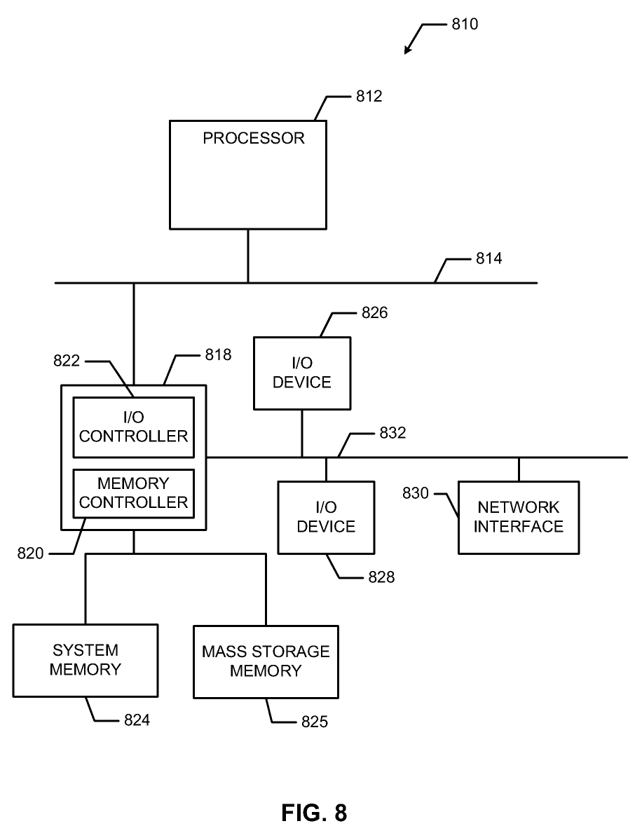

FIG. 8 is a block diagram of an example processor system 810 that may be used to implement systems and methods described herein. As shown in FIG. 8, the processor system 810 includes a processor 812 that is coupled to an interconnection bus 814. The processor 812 may be any suitable processor, processing unit, or microprocessor, for example. Although not shown in FIG. 8, the system 810 may be a multi-processor system and, thus, may include one or more additional processors that are identical or similar to the processor 812 and that are communicatively coupled to the interconnection bus 814.

The processor 812 of FIG. 8 is coupled to a chipset 818, which includes a memory controller 820 and an input/output (“I/O”) controller 822. As is well known, a chipset typically provides I/O and memory management functions as well as a plurality of general purpose and/or special purpose registers, timers, etc. that are accessible or used by one or more processors coupled to the chipset 818. The memory controller 820 performs functions that enable the processor 812 (or processors if there are multiple processors) to access a system memory 824 and a mass storage memory 825.

The system memory 824 may include any desired type of volatile and/or non-volatile memory such as, for example, static random access memory (SRAM), dynamic random access memory (DRAM), flash memory, read-only memory (ROM), etc. The mass storage memory 825 may include any desired type of mass storage device including hard disk drives, optical drives, tape storage devices, etc.

The I/O controller 822 performs functions that enable the processor 812 to communicate with peripheral input/output (“I/O”) devices 826 and 828 and a network interface 830 via an I/O bus 832. The I/O devices 826 and 828 may be any desired type of I/O device such as, for example, a keyboard, a video display or monitor, a mouse, etc. The network interface 830 may be, for example, an Ethernet device, an asynchronous transfer mode (“ATM”) device, an 802.11 device, a DSL modem, a cable modem, a cellular modem, etc. that enables the processor system 810 to communicate with another processor system.

While the memory controller 820 and the I/O controller 822 are depicted in FIG. 8 as separate blocks within the chipset 818, the functions performed by these blocks may be integrated within a single semiconductor circuit or may be implemented using two or more separate integrated circuits.

Thus, certain embodiments provide for access by an end user to information across enterprise systems. Certain embodiments provide a search-driven, role-based, workflow-based, and/or disease-based interface that allows the end user to access, input, and search medical information seamlessly across a healthcare network. Certain embodiments provide a technical effect of clinical data searching via an adaptive user interface that leverages semantic technology to model domain concepts, user roles and tasks, and information relationships, for example. Semantic models enable applications to find, organize and present information to users more effectively based on contextual information about the user and task. Applications can be composed from libraries of information widgets to display multi-content and multi-media information.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An information composition and query enhancement system, said system comprising:
a query generation and enhancement engine generating and conducting a query of one or more data sources based on user input and a data context to produce query results;
an information composition engine assembling the query results to provide a bundle of documents meaningful to the particular user; and
a document summarization engine clustering and summarizing the bundle of documents to provide a content summary in addition to the bundle of documents for output in a presentation to a user.

2. The system of claim 1, further comprising an information controller facilitating organization and presentation of multi-media, multi-structured information from the document summarization engine to the user.

3. The system of claim 1, further comprising a knowledge base including one or more models, ontologies, lexicons, and guidelines to frame the query, the assembling of the query results, the summarization, and the output.

4. The system of claim 1, wherein the query generation and enhancement engine accesses a connectivity framework of data registries and repositories to conduct the query of one or more data sources.

5. The system of claim 1, wherein the information composition and query enhancement system is accessible via an adaptive user interface, said adaptive user interface customizable by a user to arrange a plurality of widgets providing at least one of applications and data, one of said plurality of widgets providing a query interface to access the information composition and query enhancement system.

6. The system of claim 1, wherein the summarization engine comprises a multi-document summarization engine and a single document summarization engine.

7. The system of claim 6, wherein the single document summarization engine provides a summary of the content of a single document and the multi-document summarization engine generates a summary of content in multiple documents based on the output of the single document summarization engine.

8. The system of claim 1, wherein the query generation and enhancement engine provides query expansion and query refinement to generate query results based on a stimulus and context of a query, wherein query enhancement adds one or more additional terms to the query an wherein query refinement removes or substitutes one or more terms from the query.

9. A method for information composition and query enhancement across a healthcare enterprise, said method comprising:
generating a query for a plurality of clinical data sources based on user input;
enhancing the query based on a particular data context for the requesting user;
searching the plurality of clinical data sources using the query to provide query results;
composing the query results into a bundle relevant to the requesting user;
clustering the results in the bundle to provide a bundle of documents meaningful to the requesting user;
summarizing the clustered results to generate a content summary of the query results in the bundle; and
graphically providing the bundle of query results and the summary to the user.

10. The method of claim 9, wherein enhancing the query further comprises enhancing the query using a knowledge base including one or more models, ontologies, lexicons, and guidelines to frame the query, the assembling of the query results, the summarization, and the output.

11. The method of claim 9, wherein user input is provided and query results are accessible via an adaptive user interface customizable by a user to arrange a plurality of widgets providing at least one of applications and data, one of said plurality of widgets providing a query interface to access an information composition and query enhancement system.

12. The method of claim 9, wherein summarizing further comprises summarizing content of a single document and generating a summary of content in multiple documents based on one or more single document content summaries.

13. The method of claim 9, wherein enhancing further comprises enhancing the query via query expansion and query refinement to generate query results based on a stimulus and context of a query, wherein query enhancement adds one or more additional terms to the query an wherein query refinement removes or substitutes one or more terms from the query.

14. A machine readable medium including a set of instructions for execution by a computing machine, the set of instructions comprising:
a query generation and enhancement engine generating and conducting a query of one or more data sources based on user input and a data context to produce query results;
an information composition engine assembling the query results to provide a bundle of documents meaningful to the particular user; and
a document summarization engine clustering and summarizing the bundle of documents to provide a content summary in addition to the bundle of documents for output in a presentation to a user.

15. The machine readable medium of claim 14, further comprising an information controller facilitating organization and presentation of multi-media, multi-structured information from the document summarization engine to the user.

16. The machine readable medium of claim 14, further comprising a knowledge base including one or more models, ontologies, lexicons, and guidelines to frame the query, the assembling of the query results, the summarization, and the output.

17. The machine readable medium of claim 14, wherein the query generation and enhancement engine accesses a connectivity framework of data registries and repositories to conduct the query of one or more data sources.

18. The machine readable medium of claim 14, wherein the information composition and query enhancement system is accessible via an adaptive user interface, said adaptive user interface customizable by a user to arrange a plurality of widgets providing at least one of applications and data, one of said plurality of widgets providing a query interface to access the information composition and query enhancement system.

19. The machine readable medium of claim 14, wherein the summarization engine comprises a multi-document summarization engine and a single document summarization engine.

20. The machine readable medium of claim 19, wherein the single document summarization engine provides a summary of the content of a single document and the multi-document summarization engine generates a summary of content in multiple documents based on the output of the single document summarization engine.

21. The machine readable medium of claim 14, wherein the query generation and enhancement engine provides query expansion and query refinement to generate query results based on a stimulus and context of a query, wherein query enhancement adds one or more additional terms to the query an wherein query refinement removes or substitutes one or more terms from the query.
